(19) United States
(12) Patent Application Publication
(10) Pub. No.: US 2025/0196693 A1
(43) Pub. Date: Jun. 19, 2025

(54) VEHICLE CHARGE CONNECTOR ADAPTOR INCLUDING WIRELESS COMMUNICATION PROTOCOL

(71) Applicant: GM Global Technology Operations LLC, Detroit, MI (US)

(72) Inventors: Michael E. Pedigo, Howell, MI (US); James C. Gibbs, Brighton, MI (US)

(21) Appl. No.: 18/539,975

(22) Filed: Dec. 14, 2023

(51) Int. Cl. B60L 53/66; B60L 50/60; B60L 53/16; B60L 53/30; H02J 7/00

(52) U.S. Cl. CPC B60L 53/66; B60L 50/60; B60L 53/16; B60L 53/305; H02J 7/0042

(57) ABSTRACT

A charging connector adaptor for connecting a charging connector associated with a charging station to a charge port on a vehicle includes a housing having a plug configured to engage with the charge port and a receptacle configured to be engaged by the charging connector. A communication system is arranged in the housing. The communication system includes a signal receiver and a signal transmitter. A control system is operatively connected to the communication system. The control system is configured to communicate, through the signal transmitter, operational parameters of the charging connector adaptor to the charging station.

### INTRODUCTION

The subject disclosure relates to the art of electric vehicle charging and, more particularly, to a vehicle charge connector adaptor including a wireless communication protocol.

Electric vehicles include a rechargeable energy storage system (RESS) that provides power to an electric drive unit. The electric drive unit provides motive power for the vehicle. The RESS discharges into the electric drive unit to provide the motive power. Over time, the charge in the RESS becomes depleted. In order to replenish the charge in the RESS, the vehicle is connected to a charging station. The charging station includes a charging connector and the vehicle includes a charge port. Ideally, the charging connector can readily mate with the charge port so as to establish an electrical circuit that replenishes the RESS. The electrical connector typically dictates the charging profile of the charging station.

Currently, there multiple standardizations for charging connectors or charge ports. As such, many charging stations cannot interface with certain vehicles. In order to address this problem, there are a number of after-market adaptors available that serve as an interface between mis-matched charging connectors and charge ports. While the adaptors can facilitate the connection, the adaptors do not change the charge profile of the charging station. As not every vehicle accepts the same charge profile, the adaptors can promote improper charging.

While increasing the available charging stations for a vehicle is helpful and may add to an overall owner satisfaction, charging at an incompatible rate can damage the RESS, cause damage to the adaptor, or result in an increased charge period. Accordingly, it is desirable to provide an adaptor that may serve both as an interface between incompatible charging connectors and charge ports and also protect the RESS, the adaptor, and the charging connector from damage.

### SUMMARY

A charging connector adaptor for connecting a charging connector associated with a charging station to a charge port on a vehicle, in accordance with a non-limiting example, includes a housing having a plug configured to engage with the charge port and a receptacle configured to be engaged by the charging connector. A communication system is arranged in the housing. The communication system includes a signal receiver and a signal transmitter. A control system is operatively connected to the communication system. The control system is configured to communicate, through the signal transmitter, operational parameters of the charging connector adaptor to the charging station.

In addition to one or more of the features described herein the control system is configured to receive, through the signal receiver, charging parameters from the charging station.

In addition to one or more of the features described herein the control system is configured to communicate, through the signal transmitter, the charging parameters received from the charging station to the vehicle.

In addition to one or more of the features described herein the control system is configured to communicate, through the signal transmitter, the charging parameters to a portable electronic device operatively connected to the vehicle.

In addition to one or more of the features described herein the control system is configured to communicate, through the signal transmitter, an adaptor capability protocol to the charging station.

In addition to one or more of the features described herein the control system is configured to communicate, through the signal transmitter and the portable electronic device, the adaptor capability protocol to the charging station.

In addition to one or more of the features described herein the adaptor capability protocol includes current limitations of the charging connector adaptor.

In addition to one or more of the features described herein the portable electronic device is operatively connected to the vehicle and the charging station through a wireless cloud.

In addition to one or more of the features described herein the signal receiver and the signal transmitter are configured to receive and transmit wireless signals.

In addition to one or more of the features described herein the communication system comprises a radio frequency identification (RFID) chip.

A vehicle, in accordance with a non-limiting example, includes a body defining, at least in part, a passenger compartment, an electric drive unit supported in the body, a rechargeable energy storage system (RESS) supported by the body and operatively connected to the electric drive unit, a charge port provided at the body and electrically connected to the RESS, and a charging connector adaptor electrically connected with the charge port and configured to interface between the charge port and with a charging connector of a charging station. The charging connector adaptor includes a housing including a plug configured to engage with the charge port and a receptacle configured to be engaged by the charging connector, a communication system arranged in the housing, the communication system including a signal receiver and a signal transmitter, and a control system operatively connected to the communication system. The control system is configured to communicate, through the signal transmitter, operational parameters of the charging connector adaptor to the charging station.

In addition to one or more of the features described herein the control system is configured to receive, through the signal receiver, charging parameters from the charging station.

In addition to one or more of the features described herein the vehicle includes a communication device, the control system being configured to communicate, through the signal transmitter, the charging parameters received from the charging station to the communication device in the vehicle.

In addition to one or more of the features described herein the control system is configured to communicate, through the signal transmitter, the charging parameters to a portable electronic device operatively connected to the communication device in the vehicle.

In addition to one or more of the features described herein the control system is configured to communicate, through the signal transmitter, an adaptor capability protocol to the charging station.

In addition to one or more of the features described herein the control system is configured to communicate, through the signal transmitter and the portable electronic device, the adaptor capability protocol to the charging station.

In addition to one or more of the features described herein the adaptor capability protocol includes current limitations of the charging connector adaptor.

In addition to one or more of the features described herein the portable electronic device is operatively connected to the communication device in the vehicle and the charging station through a wireless cloud.

In addition to one or more of the features described herein the signal receiver and the signal transmitter are configured to receive and transmit wireless signals.

In addition to one or more of the features described herein the communication system comprises a radio frequency identification (RFID) chip.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a right side view of a vehicle connected to a charging station through a vehicle charge connector adaptor including a wireless communication protocol, in accordance with a non-limiting example;

FIG. 2 is depicts the vehicle charge connector adaptor prior to being connected to a charging connector of the charging station and a charge port of the vehicle, in accordance with a non-limiting example; and

FIG. 3 is a flow chart illustrating a method of charging the vehicle through the vehicle charge connector adaptor, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electrical load shown in the form of an electric drive unit 34. Electric drive unit 34 provides power to one or more of the plurality of wheels 16.

A rechargeable energy storage system (RESS) or battery assembly 38 is arranged in body 12 and provides power to electric drive unit 34. In other arrangements, a fuel cell may be used to provide power to electric drive unit 34. At this point, it should be understood that the location of electric drive unit 34 and battery assembly 38 may vary. Vehicle 10 includes a charging control system 40 that monitors and/or controls charging of battery assembly 38. Charging control system 40 includes a communication device 42. Charging control system 40 may communicate, control and/or establish charging parameters for battery assembly 38.

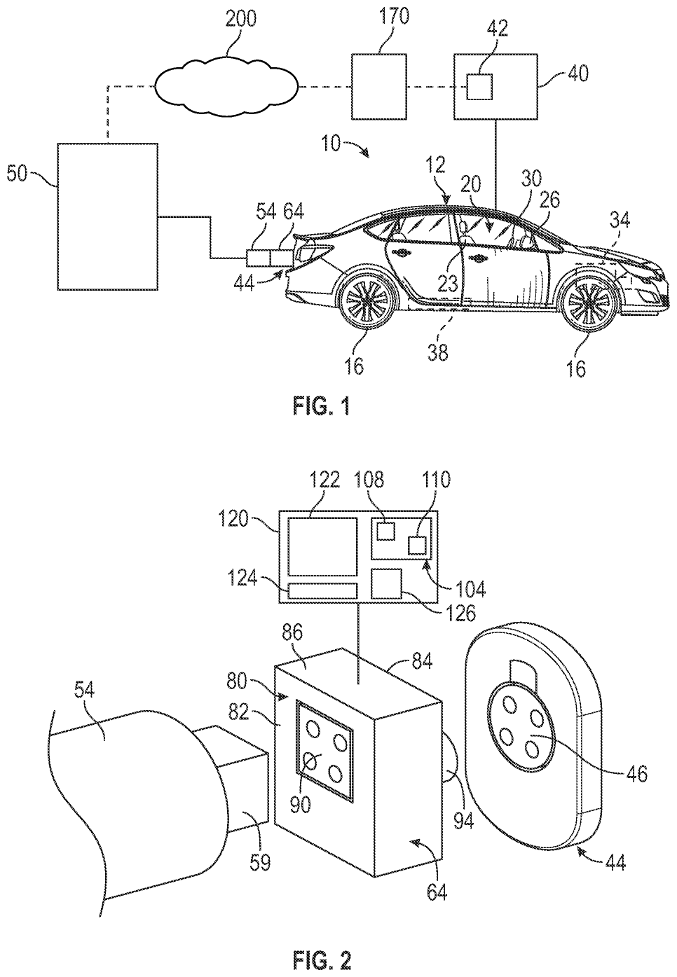

A charge port 44 having a charge port receptacle 46 (FIG. 2) is provided on body 12 and serves as an interface with a charging station 50 having a charging connector 54. Charging connector 54 includes a plug portion 59 that may directly interface with charge port receptacle 46. If a mis-match exists between plug portion 59 and charge port receptacle 46, such as shown in FIG. 2, a charging connector adaptor 64 may be used as an interface between charging connector 54 and charge port 44 on vehicle 10.

As shown in FIG. 2 charging connector adaptor 64 includes a housing 80 having a first side 82, a second side 84 that is opposite of first side 82, and an outer peripheral wall 86. The size and shape of housing 80 may vary and should not be considered to be limited to that which is shown. First side 82 includes a receptacle 90 and second side 84 includes a plug 94. Receptacle 90 is configured to interface with plug portion 59 on charging connector 54 while plug 94 is configured to connect with charge port receptacle 46 on charge port 44.

In a non-limiting example, charging connector adaptor 64 may store and communicate with charging control system 40 and/or charging station 50, charging parameters including vehicle charging characteristics and adaptor limitation protocols. In a non-limiting example, charging connector adaptor 64 includes a communication system 104 having a signal receiver 108 and a signal transmitter 110 that may facilitate wireless communication between charging control system 40 and/or charging station 50. Communication system 104 may take on various forms including Bluetooth® communication protocols, radio frequency identification (RFID) chip communication, as well as other wireless communication standards. In a non-limiting example, charging connector adaptor 64 also includes a control system 120 operatively connected with communication system 104. Control system 120 and communication system 104 may be integrated into a single component as shown in FIG. 2 or may be separate entities.

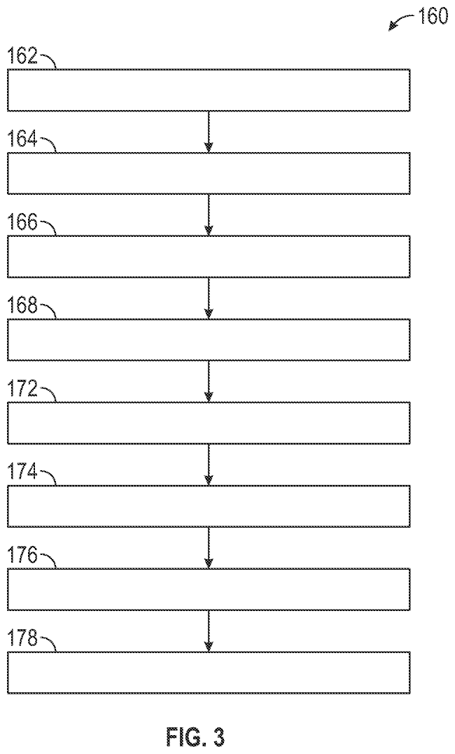

Control system 120 includes a central processing unit (CPU) 122, a non-volatile memory 124, and a communication module 126. Non-volatile memory 124 may store, for example, communication protocols as well as adaptor capability protocols including adaptor current limitations. As will be detailed herein, control system 120 ensures that charging current passing from charging station 50 meets the charging parameters of vehicle 10 and charging connector adaptor 64. Reference will now follow to FIG. 3 in describing a method 160 of charging vehicle 10 through charging connector adaptor 64. It should be understood that the particular order of method steps described herein may vary.

In a non-limiting example, charging connector adaptor 64 is connected to charging connector 54 in block 162. In block 164 charging connector 54 and charging connector adaptor 64 are connected to charge port 44. An alert may then be communicated to charging control system 40 that charging station 50 is ready to charge battery assembly 38 in block 166. In block 168, charging connector adaptor 64 may communicate charging protocols, including adaptor current limitations stored in non-volatile memory 124, directly to charging station 50. That is, signal transmitter 110 may send communication signals directly to charging station 50.

In another exemplary aspect, signal transmitter 110 may communicate with charging station 50 through communication device 42 or through a portable electronic device 170 operatively connected with communication device 42. In still a further non-limiting example, communication device 42 in vehicle 10 may communicate with charging connector adaptor 64 through signal receiver 108. Charging connector adaptor 64 may then communicate with charging station 50 through signal transmitter 108. An error check is conducted in block 172 to determine that the connection was properly made, determine current flow timing, and identify the adaptor. At this point, charging station 50 may charge battery assembly 38 at the adaptor current limitations in block 174. While charging, charging station 50 and/or vehicle 10 may monitor, in block 176, charging current passing through charging connector adaptor 64 and/or adaptor temperatures until charging is complete in block 178.

At this point, it should be understood that by providing the charging connector adaptor with communication abilities, charging components may be better protected from improper charging protocols. Charging parameters may be communicated directly to the charging station, or through an intermediary such as the vehicle or a portable device such as a smart phone. Charging parameters or abilities of the charging station may be communicated to the vehicle through the charging connector adaptor as well. Further, an adaptor capability protocol, including charging current limitations may be communicated to the charging station from the charging connector adaptor. The particular type and nature of the communication may vary. Communication may be direct peer-to-peer wireless communication protocols or communication may be facilitated through a wireless cloud such as shown at 200 in FIG. 1.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A charging connector adaptor for connecting a charging connector associated with a charging station to a charge port on a vehicle, the charging connector adaptor comprising:
a housing including a plug configured to engage with the charge port and a receptacle configured to be engaged by the charging connector;
a communication system arranged in the housing, the communication system including a signal receiver and a signal transmitter; and
a control system operatively connected to the communication system, the control system being configured to communicate, through the signal transmitter, operational parameters of the charging connector adaptor to the charging station.

2. The charging connector adaptor according to claim 1, wherein the control system is configured to receive, through the signal receiver, charging parameters from the charging station.

3. The charging connector adaptor according to claim 2, wherein the control system is configured to communicate, through the signal transmitter, the charging parameters received from the charging station to the vehicle.

4. The charging connector adaptor according to claim 3, wherein the control system is configured to communicate, through the signal transmitter, the charging parameters to a portable electronic device operatively connected to the vehicle.

5. The charging connector adaptor according to claim 4, wherein the control system is configured to communicate, through the signal transmitter, an adaptor capability protocol to the charging station.

6. The charging connector adaptor according to claim 5, wherein the control system is configured to communicate, through the signal transmitter and the portable electronic device, the adaptor capability protocol to the charging station.

7. The charging connector adaptor according to claim 6, wherein the adaptor capability protocol includes current limitations of the charging connector adaptor.

8. The charging connector adaptor according to claim 6, wherein the portable electronic device is operatively connected to the vehicle and the charging station through a wireless cloud.

9. The charging connector adaptor according to claim 1, wherein the signal receiver and the signal transmitter are configured to receive and transmit wireless signals.

10. The charging connector adaptor according to claim 1, wherein the communication system comprises a radio frequency identification (RFID) chip.

11. A vehicle comprising:
a body defining, at least in part, a passenger compartment;
an electric drive unit supported in the body;
a rechargeable energy storage system (RESS) supported by the body and operatively connected to the electric drive unit;
a charge port provided at the body and electrically connected to the RESS; and
a charging connector adaptor electrically connected with the charge port and configured to interface between the charge port and with a charging connector of a charging station, the charging connector adaptor comprising:
a housing including a plug configured to engage with the charge port and a receptacle configured to be engaged by the charging connector;
a communication system arranged in the housing, the communication system including a signal receiver and a signal transmitter; and
a control system operatively connected to the communication system, the control system being configured to communicate, through the signal transmitter, operational parameters of the charging connector adaptor to the charging station.

12. The vehicle according to claim 11, wherein the control system is configured to receive, through the signal receiver, charging parameters from the charging station.

13. The vehicle according to claim 12, wherein the vehicle includes a communication device, the control system being configured to communicate, through the signal transmitter, the charging parameters received from the charging station to the communication device in the vehicle.

14. The vehicle according to claim 13, wherein the control system is configured to communicate, through the signal transmitter, the charging parameters to a portable electronic device operatively connected to the communication device in the vehicle.

15. The vehicle according to claim 14, wherein the control system is configured to communicate, through the signal transmitter, an adaptor capability protocol to the charging station.

16. The vehicle according to claim 15, wherein the control system is configured to communicate, through the signal transmitter and the portable electronic device, the adaptor capability protocol to the charging station.

17. The vehicle according to claim 16, wherein the adaptor capability protocol includes current limitations of the charging connector adaptor.

18. The vehicle according to claim 16, wherein the portable electronic device is operatively connected to the communication device in the vehicle and the charging station through a wireless cloud.

19. The vehicle according to claim 11, wherein the signal receiver and the signal transmitter are configured to receive and transmit wireless signals.

20. The vehicle according to claim 11, wherein the communication system comprises a radio frequency identification (RFID) chip.
